(19) United States
(12) Patent Application Publication
(10) Pub. No.: US 2010/0313832 A1
(43) Pub. Date: Dec. 16, 2010

(54) Low Heat Rejection High Efficiency Engine System

(75) Inventors: Robert M. Rutherford, Geebung (AU); Paul Francis Dunn, Geebung (AU)

Correspondence Address: STEPTOE & JOHNSON LLP, 1330 CONNECTICUT AVENUE, N.W., WASHINGTON, DC, 20036, US

(73) Assignee: ROTEC DESIGN LTD, Geebung, Queensland (AU)

(21) Appl. No.: 12/602,349

(22) PCT Filed: Jun. 2, 2008
(86) PCT No.: PCT/AU2008/000791

§ 371 Date: Aug. 12, 2010

(30) Foreign Application Priority Data
Jun. 1, 2007 (AU) 2007902967

(51) Int. Cl. F02B 33/04

(52) U.S. Cl. 123/66

(57) ABSTRACT

An improved low heat rejection high efficiency engine system for an insulated two stroke internal combustion engine which includes an insulation component provided in association with at least one combustion chamber in order to minimise heat loss during operation, the system having at least one inlet port fluidly connected to a transfer port from a pumping cylinder for inlet of a fresh charge in an induction portion of the operation cycle, the inlet port opened and closed during the operation cycle by an inlet valve, characterized in that the period for which the inlet valve is open during the operation cycle is less than 180° of rotation.

### FIELD OF THE INVENTION

The present invention relates to vehicle engines and power trains and in particular to improving the efficiency of low heat rejection engines and power trains.

### BACKGROUND ART

The inventors of the present invention have previously been active in the field of engine systems and particularly in the field of increasing the efficiency of engines as evidenced in U.S. Pat. No. 6,571,755 and U.S. Pat. No. 5,265,564, the teachings of which are incorporated by reference into this document as the present invention may be used in association with the engine taught in that document.

It is known in the art relating to internal combustion engines that the application of insulation strategies (including coatings, air-gaps, inserts or use of low heat transfer materials for components) to surfaces that are exposed to hot working gases may improve operating thermal efficiency.

However in practice, as evidenced by the prior art, such strategies tend to produce significantly less operating efficiency improvement than proposed or surmised.

Four-stroke cycle engines generally dominate the market, other than at the very small (e.g. weed trimmers and scooters) and very large (e.g. container ships) ends.

A conventional engine rejects between a quarter to a third of the energy obtained by combustion of fuel to the cooling system. Insulation strategies are intended to limit or reduce that energy loss, and capture it either in-cylinder (as crankshaft work output) or in the exhaust (as increased heat flow in the exhaust gas then converted to work by some means such as a turbo-compounding device). By capturing the retained heat, overall engine thermal efficiency is improved.

Much work has been done in this field since the 1980's as evidenced by technical publications such as Society of Automotive Engineers publication SP-571—Adiabatic Engines Worldwide Review, as well as documents such as U.S. Pat. Nos. 4,018,194, 4,046,114 and 4,074,671 for example.

It can be understood from analysis of the materials that the cost/benefit of such strategies is hampered by the lower level of thermal benefit practically obtained than was originally conceived and the insulation of engines has gradually fallen from favour.

In large part this is due to degraded volumetric efficiency of the engine once insulation strategies are applied. Since the combustion chamber surface and cylinder wall temperatures of the insulated engine are higher (typically by 200° C. or more) than that of the standard liquid-cooled engine, the air (or fresh charge) induced into the cylinder during the intake cycle absorbs significantly more heat from its surrounds, and expands thus reducing the mass of fresh charge trapped in the cylinder and hence volumetric efficiency.

With less fresh charge trapped, there is general combustion degradation resulting in poor thermal efficiency and increased criteria pollutant emissions.

Other results from this heat absorption include:
air/fuel mixing become inefficient because of short ignition delay (due to higher air temperature) and increased viscosity of the air at the higher temperatures and pressures;
because the intake charge is at higher temperature and pressure the amount of compression work required is increased.

It would therefore be a substantial contribution to the art to provide a system and apparatus which when used in association with an insulated engine in order to capture the overall engine thermal efficiency benefits of insulating an engine, decreases combustion degradation and pollutant emissions from an insulated engine.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to an improved low heat rejection high efficiency engine system, which may at least partially overcome at least one of the abovementioned disadvantages or provide the consumer with a useful or commercial choice.

With the foregoing in view, the present invention in one form, resides broadly in an improved low heat rejection high efficiency engine system for an insulated two-stroke internal combustion engine which includes an insulation component provided in association with at least one combustion chamber in order to minimise heat loss during operation, the system having at least one inlet port fluidly connected to a transfer port from a pumping cylinder for inlet of a fresh charge in an induction portion of the operation cycle, the inlet port opened and closed during the operation cycle by an inlet valve, characterized in that the period for which the inlet valve is open during the operation cycle is less than 180° of rotation.

In a second form, the invention resides in a method of increasing efficiency for an insulated two stroke internal combustion engine which includes an insulation component provided in association with at least one combustion chamber in order to minimise heat loss during operation, the engine having at least one inlet port fluidly connected to a transfer port from a pumping cylinder for inlet of a fresh charge in an induction portion of the operation cycle, the inlet port opened and closed during the operation cycle by an inlet valve, the method including the step of shortening the period for which the inlet valve is open during the operation cycle to less than 180° of rotation.

In a third form, the invention resides in a two stroke internal combustion engine comprising at least one unit having a pumping cylinder, a pumping piston reciprocally movable in said pumping cylinder, two power cylinders, a respective power piston reciprocally movable in each said power cylinder, each said power cylinder having an associated combustion chamber, the pumping piston reciprocating at a cycle speed twice that of the power pistons and said power pistons being phased about one stroke apart, a cylinder head or heads closing top ends of all said cylinders, said head or heads having ports therethrough enabling said pumping cylinder to communicate with said power cylinders, inlet valves controlling communication between the pumping cylinder and the power cylinders, exhaust ports through said head or heads allowing exhaust gases to flow from the power cylinders, exhaust valves controlling the flow of the exhaust gases, at least one intake port through the pump head and communicating with the pumping cylinder, intake valve means associated with the intake port and allowing a major portion of intake charge to be induced into the pumping cylinder when the pumping piston is moving away from its top dead centre position and said pumping piston alternately transferring the charge into the power cylinders through the transfer and inlet ports as the pumping piston moves towards its top dead centre position, said pumping piston leads to the top dead centre position the power piston of the cylinder to which the charge is transferred, the inlet valves of the power cylinders begin to open when the pumping piston is positioned between 70 degrees after top dead centre and 290 degrees after top dead centre and close when the pumping piston is positioned between 70 degrees before top dead centre and 70 degrees after top dead centre, the exhaust valves opening when the associated said power piston is at about or before its bottom dead centre position, wherein the period for which the inlet valve is open during the operation cycle is less than 180° of rotation.

In a fourth form, the invention resides in a two stroke reciprocating engine having head mounted inlet and exhaust valves and an external pump for charging the cylinders, wherein: the external pump is a reciprocating positive displacement pump having a respective pumping chamber (or cylinder) for groups of at least two cylinders of the engine, each pumping chamber (or cylinder) having a displacement swept by its pumping piston which is greater than the swept cylinder displacement of each cylinder of the engine; the pump is secured to a mounting on the engine adjacent the cylinders whereby the outlet from the pump is located closely adjacent the inlets of the engine; the crank pins of the engine's crankshaft are arranged at angular spacings of 360.degree. divided by the number of cylinders in the group; the crank pins for each group of cylinders are arranged at angular spacings of 360.degree. divided by the number of cylinders in the group; step-up drive means is provided for driving the pump from the engine, the step-up being in the ratio of the number of cylinders in each group of cylinders of the engine per pumping chamber (or cylinder); feed passages are provided through transfer manifolding interconnecting the outlet from each pumping chamber (or cylinder) to the inlets of the group of cylinders to be fed thereby, and the connection between the engine and the pump and the operation of the inlet and exhaust valves of the engine are timed such that: the or each pumping piston leads alternate ones of the power pistons fed thereby to their respective Top Dead Centre (TDC) positions; the inlet valve to each power cylinder to be fed opens before Bottom Dead Centre (BDC) and closes before TDC, and the outlet valve from the fed power cylinder opens before BDC and closes before TDC and wherein the period for which the inlet valve is open during the operation cycle is less than 180° of rotation.

In a fifth form, the invention resides in method of converting a four-stroke reciprocating piston engine into a two-stroke engine including: providing a reciprocating positive displacement pump having a respective pumping chamber (or cylinder) for groups of at least two cylinders of the engine, each pumping chamber (or cylinder) having a displacement swept by its pumping piston which is greater than the swept cylinder displacement of each cylinder of the engine; securing the pump to a mounting on the engine adjacent the cylinders whereby the outlet from the pump is located closely adjacent the inlets of the engine; arranging the crank pins for each group of cylinders at angular spacings of 360.degree. divided by the number of cylinders in the group; providing step-up drive means for driving the pump from the engine, the step-up being in the ratio of the number of cylinders in each group of cylinders of the engine per pumping chamber (or cylinder); providing feed passages through transfer manifolding interconnecting the outlet from each pumping chamber (or cylinder) to the inlets of the group of cylinders to be fed thereby, and timing the connection between the engine and the pump and the operation of the inlet and exhaust valves of the engine such that: the or each pumping piston leads alternate ones of the power pistons fed thereby to their respective Top Dead Centre (TDC) positions; the inlet valve to each power cylinder to be fed opens before Bottom Dead Centre (BDC) and closes before TDC, and the outlet valve from the fed power cylinder opens before BDC and closes before TDC and wherein the period for which the inlet valve is open during the operation cycle is less than 180° of rotation.

Using insulation strategies with the engine system allows the system of the present invention to capture the overall engine thermal efficiency benefits of insulating an engine, whilst substantially reducing the amount of heat absorbed by the incoming fresh charge because the intake charge is delivered to the cylinder in approximately 50% of the time compared with a conventional 4-stroke engine. That means there is substantially less time and opportunity for heat absorption by the incoming charge which lead to the disadvantages discussed above.

Other advantages include:
air/fuel mixing that is less efficient due to degradation of turbulence that is caused during intake in a conventional insulated 4-stroke is aided in the present invention by the increased turbulence due to the higher gas transfer rates during induction;
increased cylinder pressure due to insulation strategies is handled well by the system of the present invention in that the two-cycle operation means a lower cylinder pressure operation (as a baseline pre-insulation) relative to the 4-stroke.

The insulation material preferred in the present invention will normally be or include ceramic materials. The properties of ceramic materials are dependent on many factors such as starting powders and fabrication techniques. Most ceramic fabrication techniques have been applied to zirconia materials such as dry pressing, isostatic pressing, injection moulding, extrusion and tape casting. Addition of impurities during processing may also introduce flaws and degrade properties reducing the usefulness of any insulative lining that may then be achieved with the insulation.

Methods of insulation:

1. Spraying surfaces with an insulative coating;

2. Fitting pre-made insulating components to engine parts; or

3. A combination of these methods.

Surfaces of the engine and/or combustion chamber which will typically be insulated include:

1. Fire deck (part of cylinder head exposed to combustion) but can include the whole of the cylinder head face for practicality.

2. Piston crown including any bowl shape in piston.

3. Valve surfaces exposed to combustion chamber when valves closed.

4. Valve seat insert (excluding sealing face).

5. Injector surface exposed to combustion chamber.

6. Pre-Combustion chamber.

7. Exhaust port, Exhaust Manifold.

It is also possible that component liners may be provided which would ideally be fitted inside the cylinder, for example and then the piston sized to be closely received within the liner.

TABLE 1
Potential Insulation Materials

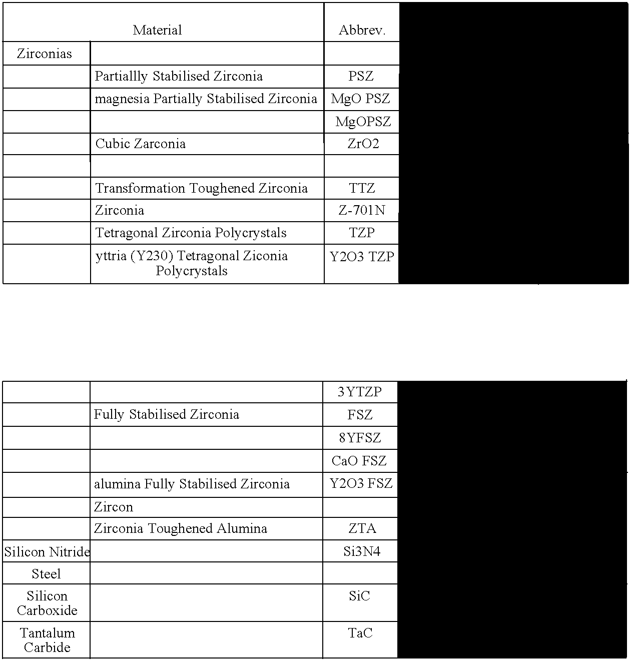

A summary of insulating materials which may find application in the present invention, and their relative properties is given in Table 1 above. Whilst not wishing to be limited by theory, two of the important characteristics of insulating materials useful in the present invention are:

Specific heat less than 0.3 cal/gdegC; and

Thermal conductivity less than 25 W/mdegK.

Materials other than those identified in the table may be used.

According to the invention, the period for which the inlet valve is open during the operation cycle is less than 180° of rotation. As discussed above, a normal 4-stroke cycle has the inlet valve open for approximately 220° of rotation.

The timing of valve opening is measured in degrees (°) while the amount of opening is measured in thousandths of inches (or mm) and is called lift. The size of the cam lobes typically determines the lift while the shape of the cam lobe typically determines the timing.

It is preferred that the inlet valve is open during the operation cycle for between approximately 100° to 180° of rotation and a particularly preferred range is between approximately 100° to 140° of rotation.

The advantages of the invention are partially realized through the increased velocity of the fresh charge of air (or inlet gases) into the combustion chamber required to inject the same charge in a shorter period.

As the shape of the respective cam lobe on the camshaft typically determines the timing of the valve opening and closing, the duration for which the inlet valve is open will typically be adjusted by changing the shape of the cam lobe. The present invention may include a variable valve timing cam system to maximize efficiency of an insulated engine at different engine speeds.

### BRIEF DESCRIPTION OF THE DRAWINGS

Various embodiments of the invention will be described with reference to the following drawings, in which:

FIG. 1 is a schematic representation of an engine cylinder showing the possible positions in which insulating materials may be applied according to the present invention.

FIG. 1A is a detailed schematic representation of an upper portion of the cylinder illustrated in FIG. 1 showing the possible position of insulation in dotted outline.

FIG. 2 is a valve timing diagram for a conventional 4-stroke engine cycle.

### DETAILED DESCRIPTION OF THE PREFERRED EMBODIMENT

According to a preferred embodiment, an improved low heat rejection high efficiency engine system for an insulated two stroke internal combustion engine is provided.

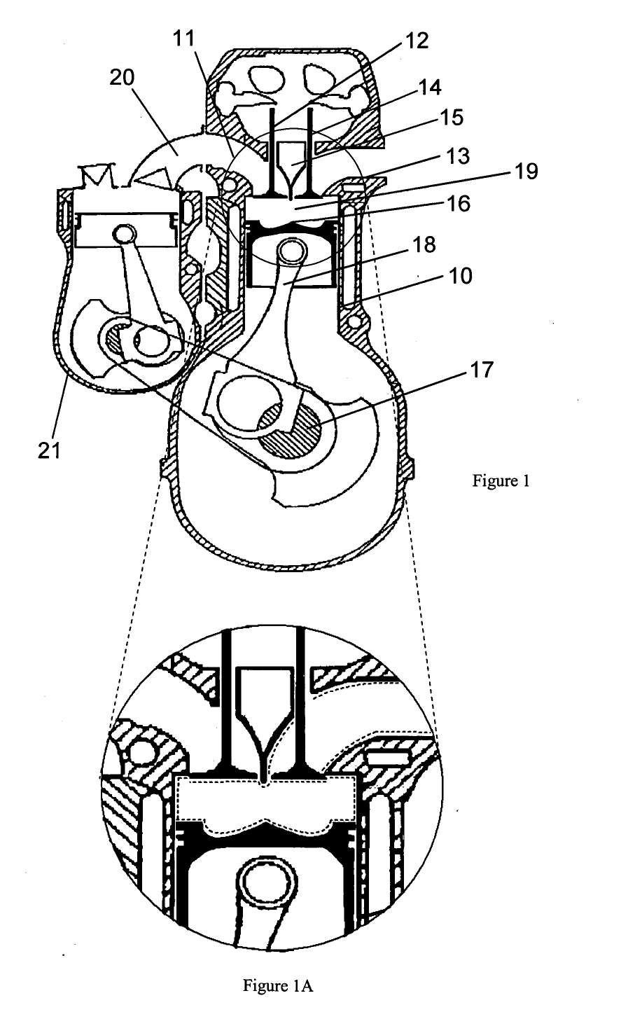

One cylinder 10 of a typical two stroke internal combustion engine of the type disclosed by U.S. Pat. No. 6,571,755 and U.S. Pat. No. 5,265,564 is illustrated in FIG. 1 and is associated with an inlet port 11 and a transfer port 20 for inlet of a fresh charge which is supplied from a pump 21 during an induction phase of the operation cycle and which is opened and closed during the operation cycle by an inlet valve 12. The cylinder 10 is also associated with an outlet port 13 for outlet of an exhaust charge in an exhaust phase of the operation cycle and which is opened and closed during the operation cycle by an outlet valve 14.

The cylinder arrangement illustrated also includes a injector 15, and a piston 16 connected to a crankshaft 17 by a connecting rod 18. A combustion chamber 19 is defined by a fire deck (part of cylinder head exposed to combustion) and the piston crown (including bowl contour of the piston 16).

Insulation will typically be provided on any one or more of

1. The fire deck;

2. Piston crown including any bowl shape in piston;

3. Valve surfaces exposed to combustion chamber when valves closed;

4. Valve seat insert (excluding sealing face);

5. Injector surface exposed to combustion chamber;

6. Pre-Combustion chamber (if provided); and/or

7. Exhaust port 13, Exhaust Manifold.

This is a typically construction of a prior art low heat rejection engine.

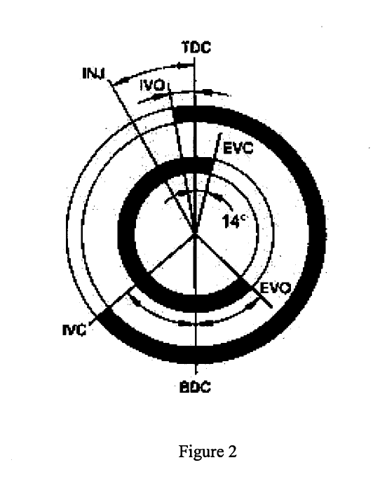

A valve timing diagram for a conventional 4-stroke engine is illustrated in FIG. 2.

In FIG. 2, the reference letters refer to the following actions occurring in the 4-stroke cycle:
IVO—Inlet Valve Opens
IVC—Inlet Valve Closes
EVO—Exhaust Valve Opens
EVC—Exhaust Valve Closes
TDC—Top Dead Centre
BDC—Bottom Dead Centre
INJ—Injection

It can be clearly seen from this figure that the timing between NO and IVC in the conventional 4-stroke engine is approximately 220°.

According to the most preferred embodiment of the present invention, the period for which the inlet valve 12 is open during the operation cycle is less than 180° between approximately 100° to 140° of rotation. A window when the inlet valve 12 would open according to the present invention is illustrated between the points EVO and BDC as illustrated in FIG. 2. Closing the inlet valve 12 at or about NC will typically result in the above-described advantages being realized.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. An improved low heat rejection high efficiency engine system for an insulated two stroke internal combustion engine which includes an insulation component provided in association with at least one combustion chamber in order to minimise heat loss during operation, the system having at least one inlet port fluidly connected to a transfer port from a pumping cylinder for inlet of a fresh charge in an induction portion of the operation cycle, the inlet port opened and closed during the operation cycle by an inlet valve, characterized in that the period for which the inlet valve is open during the operation cycle is less than 180° of rotation.

2. A two stroke internal combustion engine comprising at least one unit having a pumping cylinder, a pumping piston reciprocally movable in said pumping cylinder, two power cylinders, a respective power piston reciprocally movable in each said power cylinder, each said power cylinder having an associated combustion chamber, the pumping piston reciprocating at a cycle speed twice that of the power pistons and said power pistons being phased about one stroke apart, at least one cylinder head closing top ends of all said cylinders, said at least one head having ports there through enabling said pumping cylinder to communicate with said power cylinders, inlet valves controlling communication between the pumping cylinder and the power cylinders, exhaust ports through said head allowing exhaust gases to flow from the power cylinders, exhaust valves controlling the flow of the exhaust gases, at least one intake port through the head and communicating with the pumping cylinder, intake valve means associated with the intake port and allowing a major portion of intake charge to be induced into the pumping cylinder when the pumping piston is moving away from its top dead centre position and said pumping piston alternately transferring the charge into the power cylinders through the transfer ports as the pumping piston moves towards its top dead centre position, said pumping piston leads to the top dead centre position the power piston of the cylinder to which the charge is transferred, the inlet valves begin to open when the pumping piston is positioned between 70° after top dead centre and 290° after top dead centre and close when the pumping piston is positioned between 70° before top dead centre and 70° after top dead centre, the exhaust valves opening when the associated said power piston is at about or before its bottom dead centre position, wherein the period for which the inlet valve is open during the operation cycle is less than 180° of rotation.

3. A two stroke reciprocating engine having head mounted inlet and exhaust valves and an external pump for charging the cylinders, wherein: the external pump is a reciprocating positive displacement pump having a respective pumping chamber for groups of at least two cylinders of the engine, each pumping chamber having a displacement swept by its pumping piston which is greater than the swept cylinder displacement of each cylinder of the engine; the pump is secured to a mounting on the engine adjacent the cylinders whereby the outlet from the pump is located adjacent the inlets of the engine; the crank pins of the engine's crankshaft are arranged at angular spacings of 360° divided by the number of cylinders in the group; the crank pins for each group of cylinders are arranged at angular spacings of 360V divided by the number of cylinders in the group; step-up drive means is provided for driving the pump from the engine, the step-up being in the ratio of the number of cylinders in each group of cylinders of the engine per pumping chamber; feed passages are provided through transfer manifolding interconnecting the outlet from each pumping chamber to the inlets of the group of cylinders to be fed thereby, and the connection between the engine and the pump and the operation of the inlet and exhaust valves of the engine are timed such that: the or each pumping piston leads alternate ones of the power pistons fed thereby to their respective Top Dead Centre (TDC) positions; the inlet valve to each power cylinder to be fed opens before Bottom Dead Centre (BDC) and closes before TDC, and the outlet valve from the fed power cylinder opens before BDC and closes before TDC and wherein the period for which the inlet valve is open during the operation cycle is less than 180° of rotation.

4. An engine as claimed in claim 2 including insulation applied to at least one engine component by either spraying surfaces with an insulative coating or fitting pre-made insulating components to engine parts or a combination thereof.

5. An engine as claimed in claim 2 including insulation of a ceramic material.

6. An engine as claimed in either claim 4 wherein surfaces of the engine and/or combustion chamber which are insulated include a fire deck, piston crown including any bowl shape in piston, valve surfaces exposed to combustion chamber when valves closed, valve seat insert, injector surface exposed to combustion chamber, pre-combustion chamber, exhaust port, or exhaust manifold.

7. An engine as claimed in claim 1 wherein the specific heat of the insulating material used is less than 0.3 cal/g° C.

8. An engine as claimed in claim 1 wherein the thermal conductivity of the insulating material used is less than 25 W/m° K.

9. An engine as claimed in claim 1 wherein the inlet valve is open during the operation cycle for between approximately 100° to 180° of rotation.

10. An engine as claimed in claim 1 wherein the inlet valve is open during the operation cycle for between approximately 100° to 140° of rotation.

11. An engine as claimed in claim 1 wherein the increased velocity of the fresh charge of inlet gas into the combustion chamber required to inject the same charge in a shorter period increases efficiency.

12. An engine as claimed in claim 1 wherein the duration for which the inlet valve is open is adjusted by changing the shape of a cam lobe associated with the inlet valve.

13. An engine as claimed in claim 1 further including a variable valve timing cam system to maximize efficiency of an insulated engine at different engine speeds.

14. A method of increasing efficiency for an insulated two stroke internal combustion engine which includes an insulation component provided in association with at least one combustion chamber in order to minimise heat loss during operation, the engine having at least one inlet port fluidly connected to a transfer port from a pumping cylinder for inlet of a fresh charge in an induction portion of the operation cycle, the inlet port opened and closed during the operation cycle by an inlet valve, the method including the step of shortening the period for which the inlet valve is open during the operation cycle to less than 180° of rotation.

15. A method of converting a four-stroke reciprocating piston engine into a two-stroke engine including: providing a reciprocating positive displacement pump having a respective pumping chamber for groups of at least two cylinders of the engine, each pumping chamber having a displacement swept by its pumping piston which is greater than the swept cylinder displacement of each cylinder of the engine; securing the pump to a mounting on the engine adjacent the cylinders whereby the outlet from the pump is located adjacent the inlets of the engine; arranging the crank pins for each group of cylinders at angular spacings of 360° divided by the number of cylinders in the group; providing step-up drive means for driving the pump from the engine, the step-up being in the ratio of the number of cylinders in each group of cylinders of the engine per pumping chamber; providing feed passages through transfer manifolding interconnecting the outlet from each pumping chamber to the inlets of the group of cylinders to be fed thereby, and timing the connection between the engine and the pump and the operation of the inlet and exhaust valves of the engine such that: the or each pumping piston leads alternate ones of the power pistons fed thereby to their respective Top Dead Centre (TDC) positions; the inlet valve to each power cylinder to be fed opens before Bottom Dead Centre (BDC) and closes before TDC, and the outlet valve from the fed power cylinder opens before BDC and closes before TDC and wherein the period for which the inlet valve is open during the operation cycle is less than 180° of rotation.
